(19) United States
(12) Patent Application Publication
(10) Pub. No.: US 2004/0032491 A1
(43) Pub. Date: Feb. 19, 2004

(54) Frame grabber for image processing in ingress/egress control system

(76) Inventors: Don Woody, Sunderland, MD (US); Scott Firesheets, Alexandria, VA (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/222,234

(22) Filed: Aug. 15, 2002

(51) Int. Cl. H04N 7/18; H04N 9/47

(52) U.S. Cl. 348/143; 348/152

(57) ABSTRACT

A frame grabber (10) used in a security system monitoring a secure area. The frame grabber converts video images from a camera (T) to a digital format and records the converted images (I). In response to an alarm which occurs when a person attempts an unauthorized entry into the secure area, the frame grabber automatically halts the recording and commences playback of previously recorded images. The playback comprises a continuous loop (L) of images which are displayed on a video monitor (M). An operator of the security system can halt the playback at any image in the loop so to attempt to identify the person. In determining which image to display, the operator can move both forward or backward through the loop.

### CROSS REFERENCE TO RELATED APPLICATIONS

U.S. patent application Ser. No. 09/678,776 filed Oct. 4, 2000.

### STATEMENT REGARDING FEDERALLY SPONSORED RESEARCH OR DEVELOPMENT

N/A

### BACKGROUND OF THE INVENTION

This invention relates to ingress/egress control systems for monitoring access into secure areas such as airport concourses and the like, and more particularly, to use of a frame grabber for video processing of images of people trying to enter into the area through an egress passage by which people normally exit the area.

In access control for secured areas, one problem encountered is people attempting to circumvent a security checkpoint by entering the area through an exit passage. After Sep. 11, 2001, there are now heightened security measures in place in many areas, and at airport terminals in particular. Newly instituted screening procedures for monitoring people entering onto concourses at the airport oftentimes results in long lines and perceived delays in reaching one's gate. People may feel that the potential delays will cause them to miss their flight. Or, someone who has already passed through the checkpoint but has to exit the area for one reason or another may feel it is pointless to have to wait in line again since they have already been screened. Regardless of the rationale, people try to enter back into the secure area through an exit passage by which deplaning passengers leave the concourse.

These people do not appreciate that once they have breached security, procedures require that the airport be shut down, no planes are allowed to depart, and everyone, including already screened passengers, must be checked again. This causes extensive delays throughout the air system, and is extremely costly.

As described in the above cross referenced United States patent application, state-of-the-art concourse control systems are designed to continuously monitor the exit passage, alert people attempting to enter the concourse by the exit, warn them off (in the event their actions are inadvertent), and alert security personnel to the potential intrusion. As part of this monitoring and warning process, it also is important to be able to identify an intruder if his intent is, indeed, to circumvent the security screening. As part of the monitoring process, video cameras observe the exit passage. The video images they capture can be displayed on a video monitor at a control station for the security system. The images are also recorded. For display and recording purposes, a frame grabber is employed to convert the analog output from a camera into a digital format. When an alarm occurs, the recorded images can be played back at the control station so security personnel can attempt to identify the intruder. The playback comprises a continuous-loop of video images starting at one point in time, moving through a sequence of images to an ending point and then looping back to the beginning. Heretofore, frame grabbers have not allowed operators to conveniently move through the loop in order to locate and display a video image which may best show the intruder. Movement through the loop has been one way only, so if the operator passes an image, he cannot go back to it, but must loop through the images again until he gets back to the image he wants. Given the exigencies of the situation, this is a very time consuming process.

It would be particularly advantageous to employ a frame grabber in the system which allows the operator to rapidly navigate through the image loop to locate the best possible image for display so any intruder can be quickly identified and apprehended.

### BRIEF SUMMARY OF THE INVENTION

In accordance with the present invention, a frame grabber is used in a security system monitoring a secure area such as airport concourse in which persons enter the concourse through one passage and exit from the concourse through a separate, egress passage. The security system includes a video camera which monitors the egress passage, and a video monitor on which video images from the camera are displayed. The frame grabber converts the video images from an analog to a digital format and the digitized images are recorded for subsequent use. In response to an alarm which occurs when a person attempts an unauthorized entry into the secure area through the egress passage, the system automatically interrupts the recording and commences playback of previously recorded images. The playback comprises a continuous loop of the recorded images which are displayed on the video monitor. The frame grabber is also responsive to commands from an operator of the security system to halt the playback at any image in the loop so the image can be scrutinized by the operator in an to attempt to identify the intruder. The operator is now able to move rapidly forward or backward through the loop to locate a desired image to display. If the intrusion is an actual attempt to circumvent the system, a permanent record of the loop of recorded images is made for future use.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a simplified representation of a security system in which a frame grabber of the present invention is used;

FIG. 2 is a simplified block diagram of an image processing system including a frame grabber of the present invention;

FIG. 3 illustrates a sequence of image frames collected by the system for recording and playback in the event of an alarm; and,

FIG. 4 illustrates a loop arrangement for viewing the frames played back as result of an alarm.

Corresponding reference characters indicate corresponding parts throughout the several views of the drawings.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

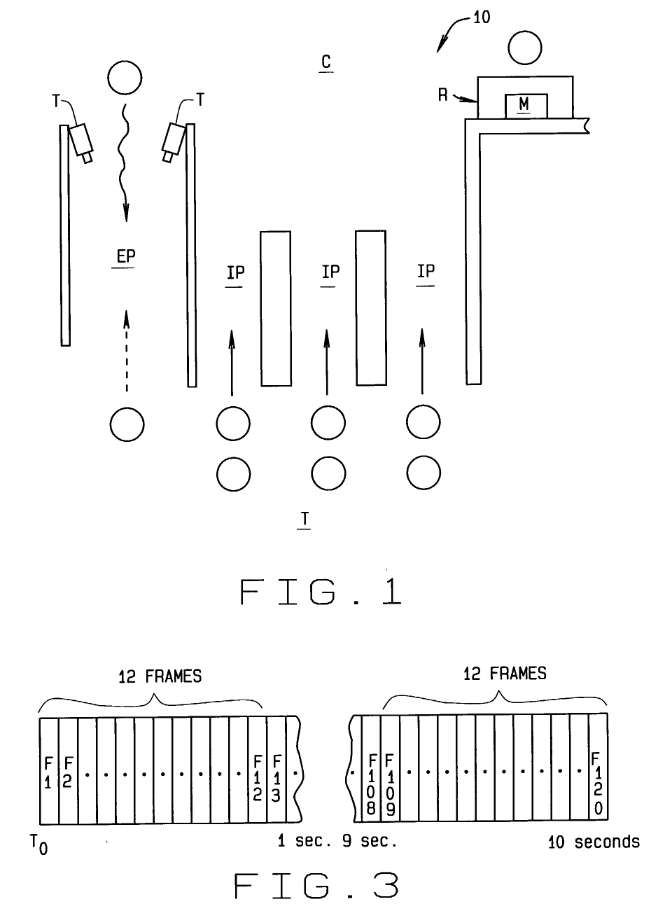

Referring to FIG. 1, a security system S is for monitoring a secure area such as the concourse C of an airport. As shown in the drawing, there is an ingress passage IP by which people move in the direction of the straight line arrows from an unsecure area such as the general terminal area T of the airport into the secure, concourse area. There is a separate egress passage EP by which people move in the direction of the wavy line arrow from the concourse back into the general terminal area. Occasionally, someone, whether intentionally or not, attempts to move along the path of the dashed line arrow into the secure area through the egress passage EP. This is not permitted. The security system includes sensors, not shown, which detect this type of movement. When such movement is detected, an alarm is given. The alarm is given at a control center R manned by guards operating the security system. In addition, audio alarms may sound at the egress passage and include warnings to the person to move back away from the passage. Flashing lights or other warnings may also be given. Besides the sensors and audio alarms, one or more television cameras T are located in the egress passage. These cameras are directed at the outlet end of the passage to obtain video imagery of anyone moving in the wrong direction through the passage. Video images from a camera are displayed on a television monitor M at the control center.

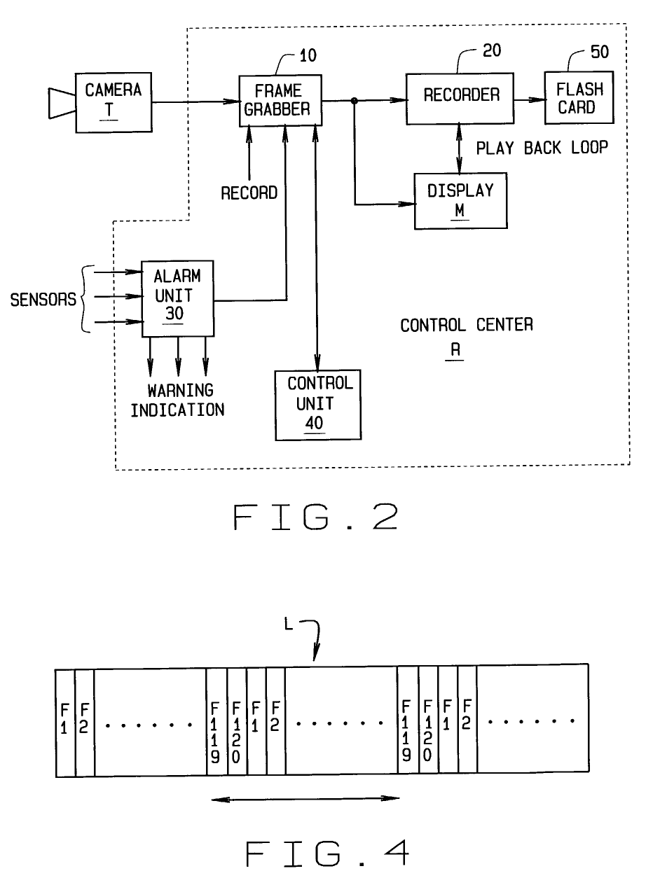

As shown in FIG. 2, images obtained by a camera T are supplied to a frame grabber 10 of the present invention. As with conventional frame grabbers, frame grabber 10 converts the images from an analog to a digital format. Camera T operates at a frame rate of 10 frames per second (fps). Accordingly, each second, frame grabber 10 processes ten separate images. The digitized images are now directed to a video recorder 20 where they are stored for subsequent use. Recorder 20 has a storage capacity of, for example, 120 frames, or twelve seconds of video. This is as shown in FIG. 3. Because incursions by someone attempting to enter concourse C through egress passage EP are an exception, it is impractical, as well as undesirable, to store all of the converted images in recorder 20. Rather, only continuous video for the last twelve seconds of operation is stored. The recorder operates such that as each new frame of video is supplied to the recorder by the frame grabber, the oldest stored frame in the recorder is discarded; i.e., its memory locations are written over by the newest frame of imagery.

When someone does attempt to breach security by moving the wrong way through egress passage EP, one or more of the sensors located in the passage will sense the alarm condition. An alarm unit 30 is responsive to an input from any of the sensors located in the egress passage sensing wrong way movement. Unit 30, as noted previously, causes an audio warning to be given, or may cause warning lights to flash. Unit 30 also provides an alarm indication to control center R alerting security personnel of the possible breach. Finally, the alarm unit supplies a signal to frame grabber 10 to interrupt the recording of frames of imagery from the cameras. In response to this command, the frame grabber stops the recording activity and immediately commences playback of the frames of video stored in recorder 20. As shown in FIG. 4, the previously recorded images comprised by frames F1-F120 are played back as a continuous loop L of the images. As indicated in FIG. 2, the loop of images is displayed on video monitor M at the control center so they can be viewed by security personnel.

A control unit 40 is located in control center R. The control unit can either be built into the control center console, or it can be incorporated into a separate, handheld unit. Control unit 40 is responsive to commands from an operator of the security system to halt playback of loop L at any recorded frame F. This is done to assist security personnel in their attempt to identify the person moving the wrong way through the egress passage One feature of control unit 40 is that it enables the operator to stop the loop at any frame, and then move both forward or backward within the loop to obtain a desired image for display. This is important because often, as an intruder moves through the egress passage into the secure area, deplaning passengers are moving in the opposite direction through the passage toward the general terminal area. Since they are passing one another, going in opposite directions, the features of the intruder will be obscured by the passengers. Because it is important to be able to positively identify the intruder, it is necessary to locate a recorded frame of video where his or her facial features, clothing, objects they are carrying, are readily identifiable. Sometimes, there is a single frame where the intruder' features are best visible. Often, some features are clearer on one frame, and other features on other frames. Those skilled in the art will appreciate that it is therefore important to be able to navigate through the loop of video as quickly as possible.

Frame grabber 10, in conjunction with control unit 40, makes this possible. As noted previously, the video recording portion of the security system, including frame grabber 10, is operable to start recording at initial power up of the system. Once the continuous loop of images starts being played back in response to an alarm, the operator can stop (freeze) the playback at any frame. That frame is now displayed on monitor M. If the operator then wishes to continue playback of the loop, he can unfreeze the loop and the playback will resume.

The operator can also move one forward through the loop one frame at a time (increment) to determine if features of the intruder are better seen in the new frame rather than the previous one. Advantageously, the operator is now also able to move one frame back at a time through the loop (decrement); again, to determine if the intruder's features are better seen in this frame. Heretofore, this ability to move backwards through the frames comprising the loop has not been available. Rather, the operator's only option was to forward through to the end of the loop, back to its beginning, and then forward again to the frames of interest. The operator would have to stop short of the frame of possible interest and move forward one frame at a time until arriving at the frame of interest. If the operator moved too quickly through the loop, he previously could not go back to a frame of interest, but would have to move forward through the loop of images until the it came around again to the frame. Now, he does not have to do that, significantly speeding up the identification process.

The operator can also save all of the recorded digitized images to a permanent storage device for future evidentiary purposes. A flash card 50 can be used for this purpose. Once the analysis of the stored and played back frames is complete, and the stored imagery has been saved, the operator can release the frame grabber and recorder to again start recording. As new frames are acquired, they are recorded as before, with the previously recorded images being overwritten by new ones.

Besides the foregoing, frame grabber 10, in conjunction with control unit 40, provides other significant capabilities for the security system. If, for example, it is not necessary to be recording video images while the security system is operating, the frame grabber can be placed in an idle mode. To then begin conversion and storage of the imagery, the operate can execute a record command. As before, when the security system is turned on, frame grabber 10 automatically begins to process and store images from a camera T.

Besides automatically stopping the recording function and initiating continuous playback of a loop of recorded images, the frame grabber and control unit can also be operated to put in place a pause between the occurrence of an alarm condition and commencement of playback. The reason for this is that the vast majority of alarm occurrences result from someone inadvertently trespassing into the egress passage. In most instances, the individual retreats back into the general terminal area as soon as they are warned. It would therefore be a waste of time to review video of a person who is no longer a threat to the security of the area. To preclude unnecessary playback, the operator can program the frame grabber to wait a brief period before stopping recording and commencing playback once an alarm has sounded. Since the video from camera T is displayed on the monitor at the control center, the operator can check to see if the person returns back into the non-secure area. If they do, then the operator can, in effect, cancel the alarm. If he does so within a predetermined interval, the frame grabber does not stop recording, but rather processes and stores new frames of video as if the alarm had not occurred. If, however, the operator does not cancel the alarm, then the frame grabber performs as above described to halt recording and begin the playback. This is helpful in the situation where even if the person retreats back into the non-secure area, something about their appearance, actions, or body language alerts security personnel to the possibility the person should be investigated.

During playback, the operator, once he has chosen a frame of imagery, can process the contents of the frame to better provide information about the intruder. Thus, for example, the operator can tag or mark a portion of an image and the have the frame grabber enlarge the marked portion. The enlargement can be any of a number of predetermined sizes. Typical enlargements would be quarter-screen, half-screen, and full screen frame enlargements. The operator can also have copies of the screen image transmitted throughout the terminal. Clearly, if the intruder is able to get through the egress passage into the secure area without being apprehended, it is important to be able to broadcast his picture so security and other airport personnel can identify him if he appears in their area. Even if the person retreats back out of the egress passage into the general terminal area, security personnel may decide that his actions were sufficiently suspicious to warrant his apprehension. In this instance, broadcasting his picture to police, airline check-in counters, and other security checkpoints is beneficial.

Finally, besides frame grabber 10 being located at the control center, the frame grabber can also be remotely located. In an airport terminal having numerous concourses, it may be advantageous to locate a number of frame grabbers associated with different cameras for the different concourses at one central location, together with their associated recorders. The video captured by the cameras and converted by the frame grabber can be displayed both locally at the control center for each concourse, as well as at the central location. In the event of an alarm, personnel at either location could control the playback to locate the frame of imagery by which the intruder can best be identified.

In view of the above, it will be seen that the several objects and advantages of the present invention have been achieved and other advantageous results have been obtained.

Having thus described the invention, what is claimed and desired to be secured by Letters Patent is:

1. A frame grabber for use with a security system that employs: i) a video camera to observe movement of people into and out of a secure area, and ii) a video monitor to display video images from the camera; the frame grabber comprising:
a converter converting video images from an analog to a digital format and recording the digitized images for subsequent use;
a means responsive to an alarm condition that occurs when a person attempts an unauthorized entry into the secure area to interrupt recording and commence a continuous-loop playback of the digitized images on the video monitor; and,
a control responsive to a command from a system operator to halt playback at any image in the continuous-loop to permit image scrutiny, the control further permitting the operator to move forward or backward within the loop to select the image to display.

2. The frame grabber of claim 1 in which the loop of images comprises a predetermined number of images recorded prior to occurrence of the alarm condition.

3. The frame grabber of claim 2 in which the system operator is automatically notified of the alarm condition and the frame grabber automatically interrupts image recording and commences recorded image playback.

4. The frame grabber of claim 3 further comprising a playback delay means delaying initiation of the recorded image playback to permit the system operator to determine whether the alarm condition is caused by an intentional or unintentional unauthorized entry.

5. The frame grabber of claim 4 responsive to a system operator input to retain the recorded image playback on a digital storage medium.

6. The frame grabber of claim 2 that, after the predetermined number of digitized images are recorded, deletes the oldest stored image each time a new recorded image is stored.

7. The frame grabber of claim 1 in which the control further enables the system operator to select a portion of a recorded image and enlarge it for display on the video monitor.

8. The frame grabber of claim 7 in which the security system includes a plurality of cameras observing the movement of people and a frame grabber is provided for use with each camera.

9. A method of observing the movement of people into and out of a secure area to determine if someone attempts an unauthorized entry into the area comprising steps:
employing a video camera to observe movement of people into and out of the secure area and recording video images from the camera for subsequent use:
converting the video images from an analog to a digital format using a frame grabber, and recording the digitized images;
responding to an alarm condition which occurs when a person attempts an unauthorized entry into the area to interrupt the recording and commence playback of a continuous-loop of the recorded digitized images;
displaying the digitized images on a video monitor to permit image scrutiny; and,
halting the playback at any image in the loop of images, and moving forward or backward within the loop to display a particular image.

10. The method of claim 9 further comprising the step of observing movement of people with a plurality of cameras and providing a frame grabber for use with each camera.

11. The method of claim 10 in which the continuous loop of images comprises a predetermined number of images recoded prior to occurrence of the alarm condition.

12. The method of claim 9 in which responding to an alarm includes automatically interrupting the recording of images and commencing the playback.

13. The method of claim 9 further comprising the step of automatically notifying an operator of the system when an alarm occurs, with the operator controlling the playback and display of the recorded images.

14. The method of claim 13 in which the frame grabber is responsive to an input from the operator to retain the recorded image playback on a digital storage medium.

15. The method of claim 13 further comprising the step of delaying initiation of the playback for the operator to determine whether the alarm condition is caused by an intentional or unintentional unauthorized entry.

16. The method of claim 9 further comprising the step of identifying a portion of an image and enlarging the portion of the image for display on the video monitor.

17. A frame grabber for use in a security system monitoring a secure area having a separate ingress and egress passages, the security system including i) a video camera observing movement of people through the egress passage, and ii) a video monitor to display video images from the camera, the frame grabber comprising:
a converter converting video images from an analog to a digital format and recording the digitized images for subsequent use;
a means responsive to an alarm condition that occurs when a person attempts an unauthorized entry into the secure area through the egress passage to automatically interrupt the recording and commence a continuous-loop playback of the digitized images on the video monitor; and,
a control responsive to a command from a system operator of the security system to halt playback at any image in the continuous-loop to permit image scrutiny, the control further permitting the operator to move forward or backward within the loop to select the image to display.

18. The frame grabber of claim 17 further comprising a playback delay means delaying initiation of the recorded image playback to permit the system operator to determine whether the alarm condition is caused by an intentional or unintentional unauthorized entry.

19. The frame grabber of claim 18 that is responsive to a system operator input to retain the recorded image played back on a digital storage medium.

20. The frame grabber of claim 17 that, after the predetermined number of digitized images are recorded, deletes the oldest stored image each time a new recorded image is stored.

21. The frame grabber of claim 17 in which the control further enables the system operator to select a portion of a recorded image and enlarge it for display on the video monitor.

22. The frame grabber of claim 17 in which the security system includes a plurality of cameras observing the movement of people and a frame grabber is provided for use with each camera.
